(19) United States
(12) Patent Application Publication
(10) Pub. No.: US 2021/0187953 A1
(43) Pub. Date: Jun. 24, 2021

(54) System And Method To Attenuate The Drying Of Aqueous Inks In A Printhead

(71) Applicant: Xerox Corporation, Norwalk, CT (US)

(72) Inventors: Chu-Heng Liu, Penfield, NY (US); Douglas K. Herrmann, Webster, NY (US); Paul J. McConville, Webster, NY (US); Jason M. LeFevre, Penfield, NY (US); Seemit Praharaj, Webster, NY (US); David A. VanKouwenberg, Avon, NY (US); Michael J. Levy, Webster, NY (US); Linn C. Hoover, Webster, NY (US); Thomas J. Wyble, Williamson, NY (US); John P. Meyers, Penfield, NY (US)

(21) Appl. No.: 16/719,327

(22) Filed: Dec. 18, 2019

(51) Int. Cl. B41J 2/17; B41J 2/045; B41J 2/165

(52) U.S. Cl. CPC B41J 2/1707; B41J 2/165; B41J 2/04566; B41J 2/04563

(57) ABSTRACT

An environmental conditioner in an aqueous inkjet printer conditions the print zone in the printer so aqueous ink at the nozzles of the printheads maintains its low viscosity state and does not dry. The environmental conditioner includes a humidifying chamber having a reservoir configured to contain a volume of water, a heater configured to heat the water in the water reservoir to a predetermined temperature range, an air inlet to move air into the humidifying chamber, an air discharge configured to remove humidified air from the humidifying chamber and direct the humidified air into a space between a faceplate of a printhead and a path for media passing by the faceplate of the printhead. The chamber can include an ultrasonic atomizer to produce a moisturized mist for absorption by the heated air or wicking material to transfer moisture to the air.

### TECHNICAL FIELD

This disclosure relates generally to devices that produce ink images on media, and more particularly, to devices that eject fast-drying ink from inkjets to form ink images.

### BACKGROUND

Inkjet imaging devices eject liquid ink from printheads to form images on an image receiving surface. The printheads include a plurality of inkjets that are arranged in some type of array. Each inkjet has a thermal or piezoelectric actuator that is coupled to a printhead controller. The printhead controller generates firing signals that correspond to digital data for images. The actuators in the inkjets of the printheads respond to the firing signals by expanding into an ink chamber to eject ink drops through the inkjet nozzles onto an image receiving member and form an ink image that corresponds to the digital image used to generate the firing signals.

Some inkjet imaging devices use inks that change from a low viscosity state to a high viscosity state relatively quickly. Aqueous inks are such inks and they can dry out quickly in inkjets that are not operated relative frequently even during printing operations. Additionally, some aqueous ink colors are more susceptible to drying than other ink colors. One way of addressing this problem is to fire inkjets that are not being used to form a portion of the ink image so ink continues to move through the inkjets and does not dry. Firing unused inkjets, however, without adversely impacting the quality of the ink image is difficult as intricate schemes are necessary to spread the extraneous ink over the ink image to camouflage the ink from the eye of a human observer. Being able to maintain the viscosity level of aqueous inks in inkjets so they do not dry during printing operations without resorting to occasional firing of the inkjets would be beneficial.

### SUMMARY

A method of inkjet printer operation conditions the print zone environment so aqueous ink at the nozzles of a printhead maintains its low viscosity state and does not dry. The method includes moving media with a media transport past a plurality of printheads, operating the printheads to form ink images on the media as the media moves past the plurality of printheads, heating water in reservoir of a humidifying chamber to a predetermined temperature range, moving air into the humidifying chamber through an air inlet to humidify the air, discharging humidified air from the humidifying chamber through an air discharge, and directing the discharged humidified air into a space between a faceplate of at least one of the printheads and a path for media passing by the faceplate of the at least one printhead.

An environmental conditioner conditions air in a print zone of an inkjet printer so aqueous ink at the nozzles of a printhead maintains its low viscosity state and does not dry. The environmental conditioner includes a humidifying chamber having a reservoir configured to contain a volume of water, a heater configured to heat the water in the reservoir to a predetermined temperature range, an air inlet to move air into the humidifying chamber, an air discharge configured to remove humidified air from the humidifying chamber and direct the humidified air into a space between a faceplate of a printhead and a path for media passing by the faceplate of the printhead.

An inkjet printer is configured with a device that conditions the print zone environment of the printer so aqueous ink at the nozzles of a printhead maintains its low viscosity state and does not dry. The printer includes a plurality of printheads, a media transport configured to move media past the plurality of printheads so the printheads form ink images on the media as the media moves past the plurality of printheads, and an environmental conditioner having a humidifying chamber having a reservoir configured to contain a volume of water, a heater configured to heat the water in the water reservoir to a predetermined temperature range, an air inlet to move air into the humidifying chamber, an air discharge configured to remove humidified air from the humidifying chamber and direct the humidified air into a space between a faceplate of a printhead and a path for media passing by the faceplate of the printhead.

### BRIEF DESCRIPTION OF THE DRAWINGS

The foregoing aspects and other features of a system and method that conditions the print zone environment of an inkjet printer so aqueous ink at the nozzles of a printhead maintains its low viscosity state and does not dry are explained in the following description, taken in connection with the accompanying drawings.

FIG. 1 is a schematic drawing of an aqueous inkjet printer that prints ink images directly to a web of media and that conditions the print zone environment in the printer so aqueous ink at the nozzles of the printheads maintains its low viscosity state and does not dry.

FIG. 2A, FIG. 2B, and FIG. 2C are schematic diagrams of different embodiments of an environmental conditioner for the printer of FIG. 1 that conditions the print zone environment in the printer so aqueous ink at the nozzles of the printheads maintains its low viscosity state and does not dry.

FIG. 3 depicts an alternative configuration of the conditioners shown in FIG. 2A, 2B, and 2C that are positioned at an entrance of a print zone in the printer of FIG. 1.

FIG. 4 is a graph of temperature and humidity levels that is used to identify the absolute maximum humidity and the minimum absolute humidity for the printer of FIG. 1 that are used to identify the maximum and minimum temperatures for the operation of the conditioners shown in FIG. 2A, FIG. 2B, and FIG. 2C.

FIG. 5 is a flow diagram of a process used to operate the printer of FIG. 1 that conditions the print zone environment in the printer so aqueous ink at the nozzles of the printheads maintains its low viscosity state and does not dry.

### DETAILED DESCRIPTION

For a general understanding of the environment for the system and method disclosed herein as well as the details for the system and method, reference is made to the drawings. In the drawings, like reference numerals have been used throughout to designate like elements. As used herein, the word “printer” encompasses any apparatus that produces ink images on media, such as a digital copier, bookmaking machine, facsimile machine, a multi-function machine, or the like. As used herein, the term “process direction” refers to a direction of travel of an image receiving surface, such as an imaging drum or print media, and the term “cross-process direction” is a direction that is substantially perpendicular to the process direction in the plane of the image receiving surface. Also, the description presented below is directed to a system for conditioning the air within the print zone of an inkjet printer to reduce evaporation of aqueous ink at the nozzles of the inkjets in the printer. As used in this document, the term “environment conditioning” means treating the ambient air in a print zone of a printer so aqueous ink at the nozzles of the printheads maintains its low viscosity state and does not dry. The reader should also appreciate that the principles set forth in this description are applicable to similar imaging devices that generate images with pixels of other marking materials.

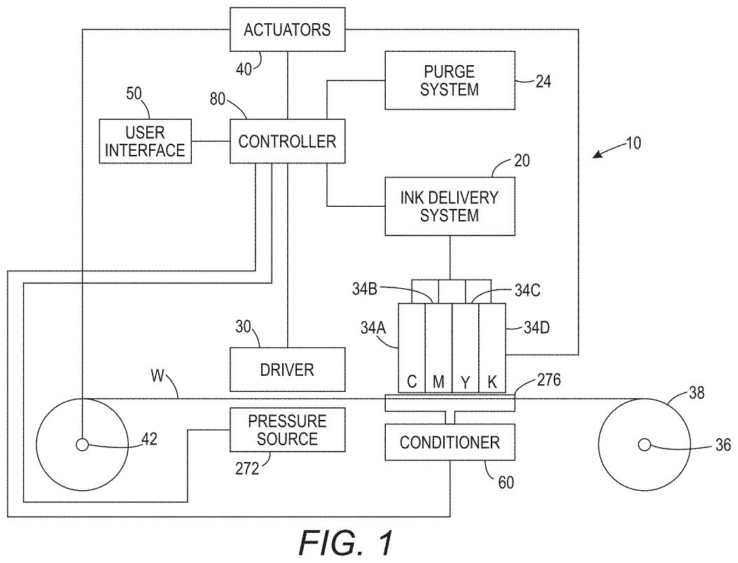

FIG. 1 illustrates a high-speed aqueous ink image producing machine or printer 10 in which a controller 80 has been configured to operate the print zone environment conditioner 60 so the aqueous ink at the nozzles of the printheads 34A, 34B, 34C, and 34D maintain a low viscosity state during printing jobs. As illustrated, the printer 10 is a printer that directly forms an ink image on a surface of a web W of media pulled through the printer 10 by the controller 80 operating one of the actuators 40 that is operatively connected to the shaft 42 to rotate the shaft and the take up roll 46 mounted about the shaft. In one embodiment, each printhead module has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads that enables media wider than a single printhead to be printed. Additionally, the printheads can also be interlaced so the density of the drops ejected by the printheads in the cross-process direction can be greater than the smallest spacing between the inkjets in a printhead in the cross-process direction.

The aqueous ink delivery subsystem 20 has at least one ink reservoir containing one color of aqueous ink. Since the illustrated printer 10 is a multicolor image producing machine, the ink delivery system 20 includes four (4) ink reservoirs, representing four (4) different colors CYMK (cyan, yellow, magenta, black) of aqueous inks. Each ink reservoir is connected to the printhead or printheads in a printhead module to supply ink to the printheads in the module. Pressure sources and vents of a purge system 24 are also operatively connected between the ink reservoirs and the printheads within the printhead modules to perform manifold and inkjet purges. Additionally, although not shown in FIG. 1, each printhead in a printhead module is connected to a corresponding waste ink tank with a valve to collect ink produced by manifold and inkjet purge operations. The printhead modules 34A-34D can include associated electronics for operation of the one or more printheads by the controller 80 although those connections are not shown to simplify the figure. Although the printer 10 includes four printhead modules 34A-34D, each of which has two arrays of printheads, alternative configurations include a different number of printhead modules or arrays within a module. The controller 80 also operates the print zone environmental conditioner 60 to preserve the low viscosity of the ink in the nozzles of the printheads in the printhead modules as described more fully below.

After an ink image is printed on the web W, the image passes under an image dryer 30. The image dryer 30 can include an infrared heater, a heated air blower, air returns, or combinations of these components to heat the ink image and at least partially fix an image to the web. An infrared heater applies infrared heat to the printed image on the surface of the web to evaporate water or solvent in the ink. The heated air blower directs heated air over the ink to supplement the evaporation of the water or solvent from the ink. The air is then collected and evacuated by air returns to reduce the interference of the air flow with other components in the printer.

As further shown, the media web W is unwound from a roll of media 38 as needed by the controller 80 operating one or more actuators 40 to rotate the shaft 42 on which the take up roll 46 is placed to pull the web from the media roll 38 as it rotates with the shaft 36. When the web is completely printed, the take-up roll can be removed from the shaft 42. Alternatively, the printed web can be directed to other processing stations (not shown) that perform tasks such as cutting, collating, binding, and stapling the media.

Operation and control of the various subsystems, components and functions of the machine or printer 10 are performed with the aid of a controller or electronic subsystem (ESS) 80. The ESS or controller 80 is operably connected to the components of the ink delivery system 20, the purge system 24, the printhead modules 34A-34D (and thus the printheads), the actuators 40, the heater 30, and the print zone environmental conditioner 60. The ESS or controller 80, for example, is a self-contained, dedicated mini-computer having a central processor unit (CPU) with electronic data storage, and a display or user interface (UI) 50. The ESS or controller 80, for example, includes a sensor input and control circuit as well as a pixel placement and control circuit. In addition, the CPU reads, captures, prepares and manages the image data flow between image input sources, such as a scanning system or an online or a work station connection, and the printhead modules 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in memory associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image data for an image to be produced are sent to the controller 80 from either a scanning system or an online or work station connection for processing and generation of the printhead control signals output to the printhead modules 34A-34D. Additionally, the controller 80 determines and accepts related subsystem and component controls, for example, from operator inputs via the user interface 50, and accordingly executes such controls. As a result, aqueous ink for appropriate colors are delivered to the printhead modules 34A-34D. Additionally, pixel placement control is exercised relative to the surface of the web to form ink images corresponding to the image data, and the media can be wound on the take-up roll or otherwise processed.

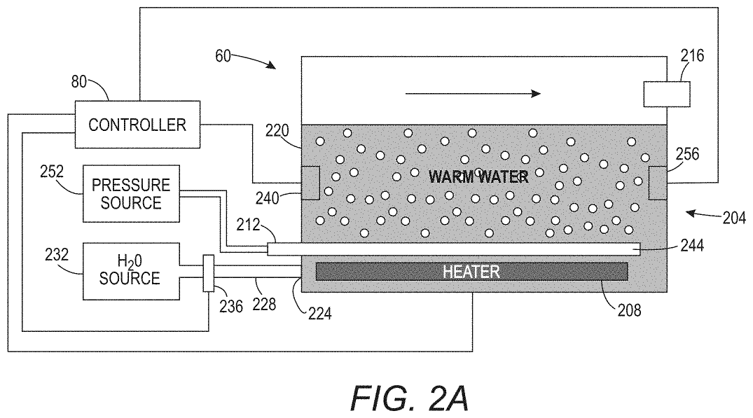

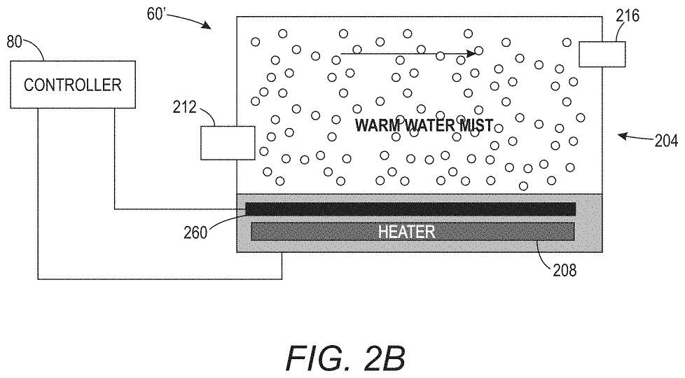

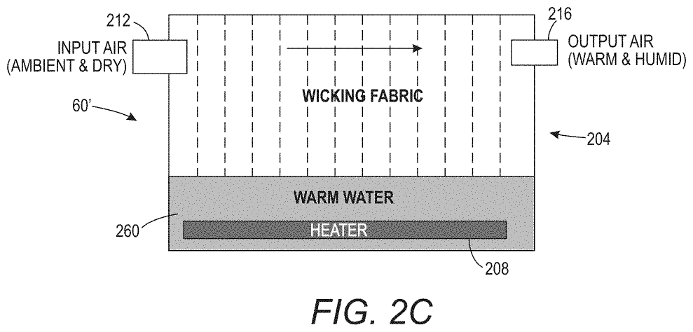

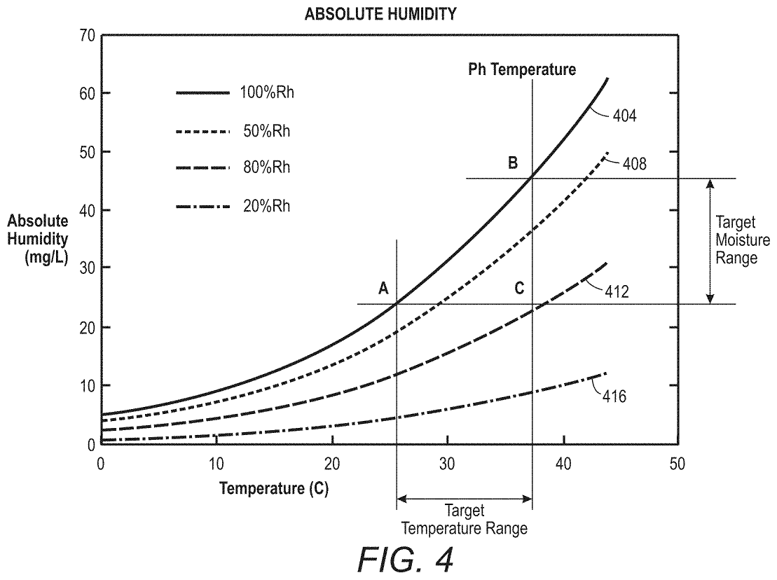

Using like numbers for like components, a print zone environmental conditioner 60 that can attenuate the evaporation of quickly drying inks from printheads is shown in FIG. 2A, FIG. 2B, and FIG. 2C. FIG. 4 depicts a flow diagram for the process 400 that operates the environmental conditioner 60 to cover the faceplates of the printheads with humidified air having a high relative humidity at an elevated temperature to preserve the viscosity of the ink in the nozzles of the printheads at a viscosity adequate to attenuate drying of the ink at the nozzles. In the discussion below, a reference to the process 400 performing a function or action refers to the operation of a controller, such as controller 80, to execute stored program instructions to perform the function or action in association with other components in the printer. The process 400 is described as being performed with the print zone environmental conditioner 60 in the printer 10 of FIG. 1 for illustrative purposes.

Three different embodiments of a print zone environmental conditioner 60, 60′, and 60″ that reduces the evaporation of aqueous ink during periods of inkjet inactivity are shown in FIG. 2A, 2B, and 2C, respectively. Each of the conditioners includes a humidifying chamber 204, a heater 208, an ambient air inlet 212, and a humidified air discharge 216. In general, ambient air enters the humidifying chamber 204 through the ambient air input 212 and, after being heated to raise the moisture capacity of the air and having the heated air humidified to an appropriate humidity level, the treated air is discharged into the print zone between the printheads and the media moving through the print zone in the process direction. The conditioners 60 differ in the configuration and types of elements used to treat the air in the humidifying chamber. In FIG. 2A, the humidifying chamber 204 includes a water reservoir 220 that is configured to hold a predetermined volume of water. A water inlet to water reservoir 220 is fluidically coupled by conduit 228 to a water source 232 and controller 80 is operatively connected to a valve 236 inserted in the conduit 228. A fluid level sensor 240 in the water reservoir 220 generates a signal that indicates the water level in the reservoir 220. The controller 80 receives the signal from the sensor 240 and is configured to operate the valve 236 so water enters the reservoir 220 when the signal from the sensor 240 indicates the water level in the reservoir is at a predetermined minimum. The controller 80 is also configured to operate the valve 236 to close the valve when the signal from the sensor 240 indicates the water level in the reservoir is at predetermined maximum. The ambient air inlet 212 is connected to a manifold 244 having perforated holes 248. The incoming ambient air is urged by a pressure source 252, such as a fan or pump, at a sufficient pressure to urge the air into the manifold 244 and out through the perorated holes in the manifold without water entering the manifold. A temperature sensor 256 is positioned in the reservoir 220 at a position below the predetermined minimum level in the reservoir and the sensor 256 generates a signal indicative of the temperature of the water in the reservoir 220. The heater 208 is also operatively connected to the controller 80 and the controller 80 is configured to operate the heater to heat the water in the reservoir when the signal from the sensor 256 indicates the temperature of the water is below a predetermined minimum temperature. When the signal from the sensor 256 indicates the water in the reservoir 220 is at or above a predetermined maximum temperature, the controller 80 is configured to deactivate the heater 208. As explained below, the maximum temperature of the water is equal to or slightly greater than the temperature of the printheads to prevent the humidified air from condensing on the faceplates of the printheads and the minimum temperature is greater than the temperature of the incoming ambient to increase the water carrying capacity of the air. Thus, the air exiting the perforated holes in the manifold 244 percolates through the heated water of the reservoir 220 so the air is heated to increase its water absorbing capacity and so the heated air becomes humified before being discharged from the humidifying chamber 204 through the air discharge 216.

In the embodiment of FIG. 2B, the water inlet 224 of the conditioner is connected to the water source 232 through a conduit 228 as described previously and the water level is monitored with a level sensor 240 so the controller can operate the valve 236 to maintain the water level at or above a predetermined minimum level as described above with regard to FIG. 2A, although those components have been left out of the figure to simplify the view. Likewise, a temperature sensor 256 is monitored by the controller 80 so the controller operates the heater 208 in a manner to keep the water in the water reservoir 220 of the humidifying chamber 204 at a temperature at or above a predetermined temperature. Again, these components are not shown in FIG. 2B to simplify the view. In the embodiment of FIG. 2B, the air inlet 212 is positioned above the maximum water level of the water in the reservoir 220. An ultrasonic atomizer 260 is operatively connected to a power source (not shown) so the ultrasonic atomizer 260 vibrates the heated water to produce a moisture mist in the humidifying chamber 204. The heated water heats the incoming air to increase the moisture capacity of the air, which absorbs the moisture mist before exiting the humidifying chamber 204 through air discharge 216.

In the embodiment of FIG. 2C, the humidifying chamber 204 is provided with a water reservoir 220 that is provided with water from a water source 232 through a water inlet 224 and conduit 228 and the level of the water in the reservoir 220 is regulated by the controller 80 using a water level sensor 240 and a valve 236 as described previously with reference to FIG. 2A, although not shown in the figure to simplify the view. The controller 80 operates the heater 208 to heat the water in the reservoir 220 and the temperature of the water in the reservoir is regulated by the controller using the signal from the temperature sensor 256 as previously described as well. The air space over the heated water in the reservoir 220 is filled with wicking fabric 268, such as woven fabrics made of cellulose fibers (cotton for example), synthetic fibers and other materials, especially woven fabrics that have been treated for enhanced hydrophilicity. The wicking fabric 268 absorbs heated moisture produced from the heated water in the reservoir 220. The incoming air inlet 212 is positioned to direct air into this wicking fabric 268 at a pressure sufficient to push the air through the wicking fabric 268 to the discharge 216. As the air travels through the wicking fabric 268, it is heated to increase its moisture capacity and this heated air absorbs moisture circulating through the wicking fabric to increase the relative humidity of the air.

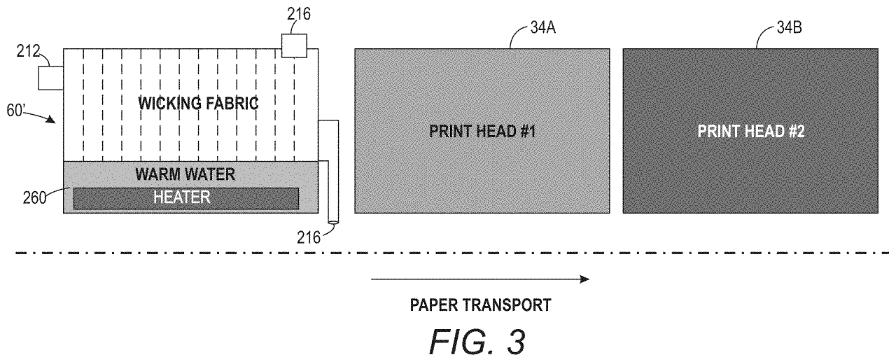

In some embodiments of these three conditioner configurations, another pressure source 272 (shown in FIG. 1), which can be another fan or pump, is operated by the controller 80 to pull the heated and humidified air from the humidified air discharge 216 and direct the humidified air into a tube or manifold 276 (FIG. 1) that extends along the length of the print zone and is parallel to the print zone. This tube or manifold 276 has perforated holes at an edge of the print zone between the printheads and the web W so the humidified air exits the tube or manifold and enters the print zone between the faceplates of the printheads and the web W moving through the print zone. The pressure source 272 is configured to maintain a velocity of this discharged air below a predetermined velocity that would disturb the flight paths of ink drops ejected from the nozzles of the inkjets toward the media moving through the print zone. The humidified air in the print zone attenuates the likelihood of the ink in the nozzles of the printheads drying in the nozzles. In other embodiments of the three configurations of conditioner 60, the conditioner 60 is located over the media immediately prior to the media entering the print zone as shown in FIG. 3. In these embodiments, the humidified air discharge 216 is configured to direct the heated and humidified air toward the media as the media enters the print zone. Thus, the humidified air is carried into the print zone by the media to attenuate the likelihood of the ink in the nozzles of the printheads drying in the nozzles.

The temperature requirements for the discharged heated air are discussed with reference to the curves depicted in FIG. 4. The heated and humidified air must be at a relative humidity level that is less than the dew point of the printheads in the print zone, otherwise, the heated and humidified air condenses on the faceplates and possibly drips onto the media. Curve 404 in FIG. 4 depicts the absolute humidity of air as the temperature of a printhead increases. As used in this document, the term “100% relative humidity” means the dew point of air at a particular temperature as illustrated by the curve 404. Curves 408, 412, and 416 represent the 80%, 50%, and 20% relative humidity levels, respectively, over the range of temperatures shown in the graph. The temperature range and relative humidity range shown in FIG. 4 are for a printhead that is operated at an exemplary temperature of 37 degrees C.

To determine the operating parameters for the print zone environmental conditioner 60, the following procedure is performed using the graph of FIG. 4. The maximum absolute humidity is determined by the dew point at the maximum printhead temperature, which is point B on the graph. The minimum absolute humidity is dependent upon the type of printhead being used and the ink being ejected and is determined empirically with experiments and this value intersects the moisture saturation curve (100% relative humidity) at point A. The temperature at point B is the maximum operating temperature Tₘₐₓ of the conditioner and it ensures the humidity does not exceed the dew point at point B. Because the air cannot reach 100% relative humidity and because potential dilution of the humidified air with ambient air in or around the print zone before the humidified air reaches a printhead face plate, Tₘₐₓ can be slightly higher than the temperature at point B. The temperature at point A is the lower limit of the minimum operating temperature Tₘᵢₙ for the conditioner. At this minimum temperature, 100% relative humidity without any loss of moisture barely provides enough moisture for keeping the ink in the nozzles adequately hydrated. Practically, Tₘᵢₙ should be significantly higher than the temperature at point A. The ranges of the operating temperature and relative humidity are illustrated by the space enclosed by the triangular-like shape ABC. If the controller controls the operating temperature of the conditioner precisely, then the optimal operating temperature of the conditioner can be set to be slightly below the temperature at point B. At this temperature, a significant range of relative humidity percentages can be tolerated and still provide enough moisture to keep the ink in the inkjets adequately hydrated. Compared to ambient air having a relative humidity of 50%, the conditioner 60 provides up to five times more moisture to the printhead faceplates at 37 degrees C. during printing without a significant risk of water condensation on the faceplates of the printheads.

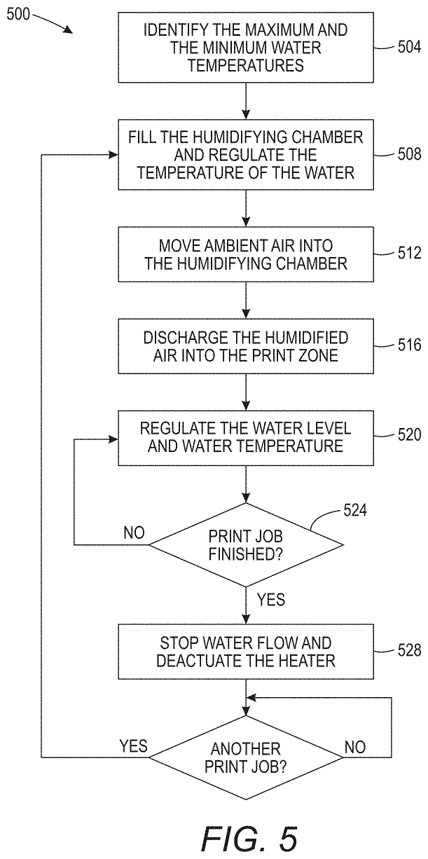

FIG. 5 depicts a flow diagram for a process 500 that operates the conditioner 60 to supply heated and humidified air to the faceplates of the printheads in the print zone of a printer during printing operations. In the discussion below, a reference to the process 500 performing a function or action refers to the operation of a controller, such as controller 80, to execute stored program instructions to perform the function or action in association with other components in the printer. The process 500 is described as being performed for a print zone environmental conditioner 60 in the printer 10 of FIG. 1 for illustrative purposes.

The process 500 begins with the maximum and minimum absolute humidity being identified and the maximum and minimum water temperatures are identified from these values (block 504). Prior to printing operations commencing, the controller fills the water reservoir 220 to an appropriate level and regulates the temperature of the water to be within the operational range (block 508). As the printing operation begins, ambient air is moved into the humidifying chamber (block 512) where it absorbs moisture and heat before being discharged into the print zone (block 516). As the printing operation continues, the controller continues the process by regulating the water level in the water reservoir as explained above and as well as the temperature of the water as explained above (block 520). When the printing operations stop (block 524), the flow of water to the humidifying chamber is disabled and the heater is deactivated (block 528) until another print job is detected (block 532).

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

1. An environmental conditioner for use in an inkjet printer comprising:
a humidifying chamber having a reservoir configured to contain a volume of water;
a heater configured to heat the water in the reservoir to a predetermined temperature range;
an air inlet to move air into the humidifying chamber;
an air discharge configured to remove humidified air from the humidifying chamber and direct the humidified air into a space between a faceplate of a printhead and a path for media passing by the faceplate of the printhead;
a water inlet to the reservoir of the humidifying chamber;
a conduit configured to connect at one end to a water source and at another end to the water inlet;
a valve operatively connected to the conduit to open and close the conduit to movement of water between the water source and the reservoir;
a water level sensor configured to generate a signal indicative of a water level in the reservoir;
a temperature sensor configured to generate a signal indicative of a temperature of the water in the reservoir; and
a controller operatively connected to the valve, the water level sensor, the heater, and the temperature sensor, the controller being configured to:
receive the signal from the water level sensor and identify whether the water level in the reservoir is above a predetermined maximum water level and below a predetermined minimum water level and to operate the valve to open the conduit so water moves through the conduit into the reservoir when the controller identifies the water level as being below the predetermined minimum water level and to close the conduit to stop water moving through the conduit into the reservoir when the controller identifies the water level as being above the predetermined maximum water level;
receive the signal from the temperature sensor and identify whether the temperature of the water in the water reservoir is above a predetermined maximum temperature and below a predetermined minimum temperature and to operate the heater to heat the water when the controller identifies the water temperature as being below the predetermined minimum water temperature and to deactivate the heater when the controller identifies the water temperature as being above the predetermined maximum water temperature;
identify a minimum absolute relative humidity for a printhead temperature operating range and to identify a maximum absolute relative humidity for the printhead temperature operating range; and
identify the predetermined maximum water temperature and the predetermined minimum water temperature using the identified minimum absolute relative humidity and the maximum absolute relative humidity.

2-3. (canceled)

4. The environmental conditioner of claim 1 further comprising:
a manifold connected to the air inlet, the manifold having perforated holes and the manifold being positioned in the reservoir below the minimum water level; and
a pressure source connected to the air inlet to move the air through the air inlet and the manifold at a predetermined pressure so the air exits the manifold through the perforated holes in the manifold and passes through the water in the reservoir before exiting the humidifying chamber.

5. The environmental conditioner of claim 1 further comprising:
an ultrasonic atomizer positioned in the reservoir below the predetermined minimum water level, the ultrasonic atomizer being configured to vibrate the water in the reservoir to produce moisturized air in the humidifying chamber and wherein the air inlet is positioned above the predetermined maximum water level in the reservoir.

6. The environmental conditioner of claim 1 further comprising:
a wicking material positioned above the predetermined maximum water level in the water chamber and wherein the air inlet is positioned to move air from the air inlet into the wicking material before the air exits through the air discharge.

7. The environmental conditioner of claim 1 further comprising:
a manifold fluidically connected to the air discharge to receive the humidified air and the manifold having a plurality of holes to distribute the humidified air along an elongated space.

8. The environmental conditioner of claim 1 wherein the air discharge is configured to direct the humidified air toward a media transport surface.

9. (canceled)

10. A printer comprising:
a plurality of printheads;
a media transport configured to move media past the plurality of printheads so the printheads form ink images on the media as the media moves past the plurality of printheads; and
an environmental conditioner further comprising:
a humidifying chamber having a reservoir configured to contain a volume of water;
a heater configured to heat the water in the reservoir to a predetermined temperature range;
an air inlet to move air into the humidifying chamber;
an air discharge configured to remove humidified air from the humidifying chamber and direct the humidified air into a space between a faceplate of a printhead and a path for media passing by the faceplate of the printhead;
a water inlet to the water reservoir;
a conduit configured to connect at one end to a water source and at another end to the water inlet;
a valve operatively connected to the conduit to open and close the conduit to movement of water between the water source and the reservoir;
a water level sensor configured to generate a signal indicative of a water level in the reservoir;
a temperature sensor positioned within the reservoir, the temperature sensor being configured to generate a signal indicative of a temperature of the water in the reservoir; and
a controller operatively connected to the valve, the water level sensor, the temperature sensor, and the heater, the controller being configured to:
receive the signal from the water level sensor and identify whether the water level in the reservoir is above a predetermined maximum water level and below a predetermined minimum water level:
operate the valve to open the conduit so water moves through the conduit into the reservoir when the controller identifies the water level as being below the predetermined minimum water level and to close the conduit to stop water moving through the conduit into the water reservoir when the controller identifies the water level as being above the predetermined maximum water level;
receive the signal from the temperature sensor and identify whether the temperature of the water in the reservoir is above a predetermined maximum temperature and below a predetermined minimum temperature;
operate the heater to heat the water when the controller identifies the water temperature as being below the predetermined minimum water temperature and to deactivate the heater when the controller identifies the water temperature as being above the predetermined maximum water temperature;
identify a minimum absolute relative humidity for a printhead temperature operating range and to identify a maximum absolute humidity for the printhead temperature operating range; and
identify the predetermined maximum water temperature and the predetermined minimum water temperature using the identified minimum absolute relative humidity and the maximum absolute relative humidity.

11-12 (canceled)

13. The printer of claim 10, the environmental conditioner further comprising:
a manifold connected to the air inlet, the manifold having perforated holes and the manifold being positioned in the reservoir below the minimum water level; and
a pressure source connected to the air inlet to move the air through the air inlet and the manifold at a predetermined pressure so the air exits the manifold through the perforated holes in the manifold and passes through the water in the reservoir before exiting the humidifying chamber.

14. The printer of claim 10, the environmental conditioner of claim 3 further comprising:
an ultrasonic atomizer positioned in the reservoir below the predetermined minimum water level, the ultrasonic atomizer being configured to vibrate the water in the reservoir to produce moisturized air in the humidifying chamber and wherein the air inlet is positioned above the predetermined maximum water level in the water reservoir.

15. The printer of claim 10, the environmental conditioner further comprising:
a wicking material positioned above the predetermined maximum water level in the water chamber and wherein the air inlet is positioned to move air from the air inlet into the wicking material before the air exits through the air discharge.

16. The printer of claim 10, the environmental conditioner further comprising:
a manifold fluidically connected to the air discharge to receive the humidified air and the manifold having a plurality of holes to direct the humidified air into a space between the media transport and the printheads.

17. The printer of claim 10 wherein the environmental conditioner is positioned opposite the media transport at a location prior to the media transport passing by the printheads and the air discharge of the environmental conditioner is configured to direct the humidified air toward a surface of the media transport.

18. (canceled)

19. A method of operating a printer comprising:
moving media with a media transport past a plurality of printheads;
operating the printheads to form ink images on the media as the media moves past the plurality of printheads;
heating water in reservoir of a humidifying chamber to a predetermined temperature range;
moving air into the humidifying chamber through an air inlet to humidify the air;
discharging humidified air from the humidifying chamber through an air discharge;
directing the discharged humidified air into a space between a faceplate of at least one of the printheads and a path for media passing by the faceplate of the at least one printhead;
generating with a water level sensor a signal indicative of a water level in the reservoir of the humidifying chamber;
receiving with a controller the signal from the water level sensor;
identifying with the controller whether the water level in the water reservoir is above a predetermined maximum water level and below a predetermined minimum water level;
operating with the controller a valve to open a conduit connecting a water source to a water inlet of the reservoir so water moves through the conduit into the reservoir when the controller identifies the water level as being below the predetermined minimum water level and to close the conduit to stop water moving through the conduit into the reservoir when the controller identifies the water level as being above the predetermined maximum water level;
generating with a temperature sensor a signal indicative of a temperature of the water in the reservoir of the humidifying chamber; and
receiving with the controller the signal generated by the temperature sensor;
identifying whether the temperature of the water in the water reservoir is above a predetermined maximum temperature and below a predetermined minimum temperature;
operating the heater to heat the water when the controller identifies the water temperature as being below the predetermined minimum water temperature and to deactivate the heater when the controller identifies the water temperature as being above the predetermined maximum water temperature;
identifying with the controller a minimum humidity for a printhead temperature operating range;
identifying with the controller a maximum humidity for the printhead temperature operating range; and
identifying the predetermined maximum water temperature and the predetermined minimum water temperature using the identified minimum humidity and the maximum humidity.

20-21 (canceled)

22. The method of claim 19 further comprising:
moving air with a pressure source through the air inlet connected to a manifold having perforated holes at a predetermined pressure so the air exits the manifold through the perforated holes in the manifold and passes through the water in the reservoir in the humidifying chamber before exiting the humidifying chamber.

23. The method of claim 19 further comprising:
vibrating the water in the reservoir of the humidifying chamber with an atomizer to produce moisturized air in the humidifying chamber.

24. The method of claim 19 further comprising:
moving air from the air inlet into a wicking material before the air exits through the air discharge.

25. The method of claim 19 further comprising:
directing the humidified air with a manifold fluidically connected to the air discharge of the humidifying chamber into a space between the media transport and the printheads.

26. The method of claim 19 further comprising:
directing the humidified air with the air discharge toward a surface of the media transport at a position before the media transport passes the plurality of printheads.

27. (canceled)
